(19) United States
(12) Patent Application Publication
(10) Pub. No.: US 2025/0013931 A1
(43) Pub. Date: Jan. 9, 2025

(54) APPARTUS AND METHOD FOR DISTILLING KNOWLEDGE FOR FLOW PREDICTION MODEL

(71) Applicants: Hyundai Kefico Corporation, Gunpo (KR); Research & Business Foundation Sungkyunkwan University, Suwon (KR)

(72) Inventors: Gyu Do Park, Anyang (KR); Soo Hyeok Kang, Incheon (KR); Jong Hwan Ko, Daejeon (KR); Wencan Cheng, Suwon (KR); Min Je Kim, Suwon (KR)

(21) Appl. No.: 18/745,564

(22) Filed: Jun. 17, 2024

(30) Foreign Application Priority Data
Jul. 3, 2023 (KR) 10-2023-0086090

(51) Int. Cl. G06N 20/20

(52) U.S. Cl. CPC G06N 20/20

(57) ABSTRACT

An apparatus for distilling knowledge for a scene flow prediction model includes: a student model former forming a student model to have single bidirectional flow embedding and a flow predictor structure of a teacher model; a weight generator generating a weight based on a plurality of hierarchical prediction results of the teacher model and predetermined ground truth data; a function generator generating a loss function by using the weight and the plurality of prediction results; and a knowledge distiller distilling the knowledge of the teacher model to the student model by using the loss function.

### CROSS-REFERENCE TO RELATED APPLICATION

This application claims under 35 U.S.C. § 119(a) the benefit of Korean Patent Application No. 10-2023-0086090 filed in the Korean Intellectual Property Office on Jul. 3, 2023, the entire contents of which are incorporated herein by reference.

### BACKGROUND

### (a) Technical Field

The present disclosure relates to an apparatus and a method for distilling knowledge for a scene flow prediction model.

### (b) Description of the Related Art

Bi-point flow net refers to a deep neural network model that receives point cloud data of at least two continuous frames as an input and extracts a scene flow feature bidirectionally to predict a scene flow of a next frame. Here, the point cloud data refers to data collected by a LiDAR sensor, an RGB-D sensor, etc., and distance information per light/signal reflected on an object, which is generated as one point in a 3D space, means a set of the points.

The bi-point flow net is constituted by four hierarchical structures in order to predict the scene flow. The four hierarchical structures can include hierarchical feature extraction, bidirectional flow embedding, upsampling, and a flow predictor.

The bi-point flow net has a disadvantage in that it takes a long time for precise prediction due to a large computation amount in a feature detection process and a flow embedding performing process at each of a source point and a target point.

Further, the bi-point flow net has a disadvantage in that a flow prediction performance deteriorates due to application of a hierarchical single flow embedding layer.

Meanwhile, in the related art, there is a method in which a student model is not generated, and a knowledge distilling method is applied to a deep neural network model to enhance the flow prediction performance.

The knowledge distilling method is utilized for the performance enhancement of the deep neural network model, but there is no effect of light-weighting which is a general purpose of knowledge distilling, and there is a problem in that the knowledge distilling method is applied only to a 2D computer vision deep learning model.

### SUMMARY

Therefore, the present disclosure provides an apparatus and a method for distilling knowledge for a scene flow prediction model which newly provide a loss function through a deep learning model using bi-directional flow embedding and a flow predictor layer of an iteration performing structure, and distill knowledge of a teacher model to a student model to enable light-weighting of the student model through the loss function.

An exemplary embodiment of the present disclosure provides an apparatus for distilling knowledge for a scene flow prediction model, which includes: a controller including: a student model former forming a student model to have single bidirectional flow embedding and a flow predictor structure of a teacher model; a weight generator generating a weight based on a plurality of hierarchical prediction results of the teacher model and predetermined ground truth data; a function generator generating a loss function by using the weight and the plurality of prediction results; and a knowledge distiller distilling the knowledge of the teacher model to the student model by using the loss function.

The weight generator may calculate a differentiation between the plurality of hierarchical prediction results of the teacher model and the ground truth data, and input the calculated differentiation into a predetermined inversed Softmax function to generate the weight.

The function generator may multiply the plurality of respective hierarchical prediction results of the teacher model by the weight, and add multiplication results to each other to calculate the loss function.

The function generator may combine the loss function with a predetermined multi scale loss function to generate a training loss function for the student model.

The knowledge distiller may distill the knowledge of the teacher model to the student model by using the training loss function.

The teacher model may have bidirectional flow embedding and a flow predictor structure of an iteration performing structure.

Another exemplary embodiment of the present disclosure provides a method for distilling knowledge for a scene flow prediction model, which includes: forming, by a student model former of a controller, a student model to have single bidirectional flow embedding and a flow predictor structure of a teacher model; generating, by a weight generator of the controller, a weight based on a plurality of hierarchical prediction results of the teacher model and predetermined ground truth data; generating, by a function generator of the controller, a loss function by using the weight and the plurality of prediction results; and a knowledge distilling step in which a knowledge distiller distilling the knowledge of the teacher model to the student model by using the loss function.

A weight generating step may include calculating, by the weight generator, a differentiation between the plurality of hierarchical prediction results of the teacher model and the ground truth data, and inputting the calculated differentiation into a predetermined inversed Softmax function to generate the weight.

A function generating step may include multiplying, by the function generator, the plurality of respective hierarchical prediction results of the teacher model by the weight, and adding multiplication results to each other to calculate the loss function. The function generating step may include combining, by the function generator, the loss function with a predetermined multi scale loss function to generate a training loss function for the student model.

A knowledge distilling step may include distilling, by the knowledge distiller, the knowledge of the teacher model to the student model by using the training loss function.

A teacher model may have bidirectional flow embedding and a flow predictor structure of an iteration performing structure.

A further exemplary embodiment of the present disclosure provides a non-transitory computer readable medium containing program instructions executed by a processor, the computer readable medium comprising: program instructions that form a student model to have single bidirectional flow embedding and a flow predictor structure of a teacher model; program instructions that generate a weight based on a plurality of hierarchical prediction results of the teacher model and predetermined ground truth data; program instructions that generate a loss function by using the weight and the plurality of prediction results; and program instructions that distill the knowledge of the teacher model to the student model by using the loss function.

According to the present disclosure, in an apparatus, a method, and a non-transitory computer readable medium for distilling knowledge for a scene flow prediction model, there is an effect in that a loss function is newly provided through a deep learning model using bi-directional flow embedding and a flow predictor layer of an iteration performing structure, and knowledge of a teacher model is distilled to a student model to enable light-weighting of the student model through the loss function.

Further, there is an effect in that the apparatus and the method for distilling knowledge for a scene flow prediction model are not limited to 2D, and are applicable to all deep learning model structure having the bi-directional flow embedding and the flow predictor layer of the iteration performing structure.

Further, there is an effect in that flow inference accuracy of the light-weighted student model is enhanced by distilling the knowledge of the scene flow prediction model.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of an apparatus for distilling knowledge for a flow prediction model according to an exemplary embodiment of the present disclosure.

FIG. 2 is a diagram illustrating a knowledge distilling process of the apparatus for distilling knowledge for a flow prediction model according to an exemplary embodiment of the present disclosure.

FIG. 3 is a diagram illustrating a loss function calculation process of the apparatus for distilling knowledge for a flow prediction model according to an exemplary embodiment of the present disclosure.

FIG. 4 is a diagram describing a generation process of a loss function.

FIG. 5 is a flowchart of a method for distilling knowledge for a scene flow prediction model according to an exemplary embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, an exemplary embodiment of the present disclosure will be described in detail with reference to the accompanying drawings. First, when reference numerals refer to components of each drawing, it is to be noted that although the same components are illustrated in different drawings, the same components are denoted by the same reference numerals as possible. Further, hereinafter, the exemplary embodiment of the present disclosure will be described, but the technical spirit of the present disclosure is not limited thereto or restricted thereby and the exemplary embodiment can be modified and variously executed by those skilled in the art.

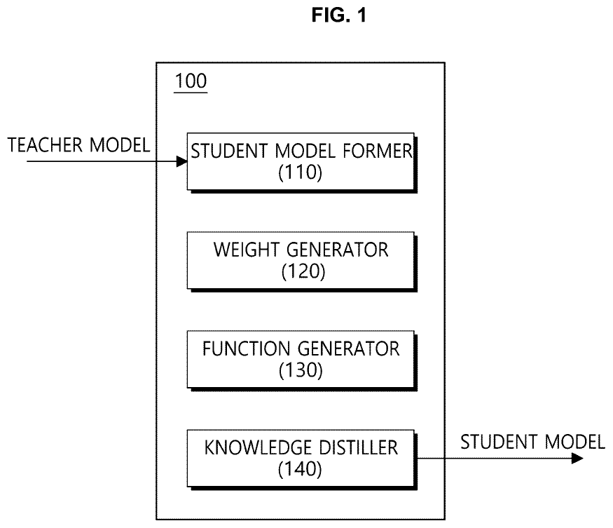

FIG. 1 is a block diagram of an apparatus for distilling knowledge for a flow prediction model according to an exemplary embodiment of the present disclosure.

Referring to FIG. 1, an apparatus 100 for distilling knowledge for a flow prediction model according to exemplary embodiment of the present disclosure newly provides a loss function through a deep learning model including bi-directional flow embedding and a flow predictor layer of an iteration performing structure, and distills knowledge of a teacher model to a student model to enable light-weighting of the student model through the newly provided loss function.

The apparatus 100 for distilling knowledge for a flow prediction model according to exemplary embodiment of the present disclosure includes a student model former 110, a weight generator 120, a function generator 130, a knowledge distiller 140.

Each of the above elements may constitute modules and/or devices of the apparatus 100, which may be a controller. For example, the above elements of the apparatus 100 may constitute hardware components that form part of a controller (e.g., modules or devices of a high-level controller), or may constitute individual controllers each having a processor and memory. The apparatus 100 may include one or more processors and memory.

The student model former 110 may form a student model so that a teacher model adopting bidirectional flow embedding of an iteration performing structure and a flow predictor are applied has single bidirectional flow embedding except for a repeated part and a flow predictor structure.

Here, the teacher model may be a kind of deep neural network model including a bi-point flow net. The teacher model may adopt a hierarchical feature detector detecting a hierarchical feature of point cloud data of continuous scene frames, an upsampling structure upsampling the detected hierarchical feature, bidirectional flow embedding of an iteration performing structure, and a flow predictor structure.

The bidirectional flow embedding structure may detect a bidirectional scene flow feature for each hierarchy of each of the source point and the target point. The bidirectional flow embedding structure may repeatedly perform a bidirectional scene flow feature detection process by using a detection value as an input.

The flow predictor structure may predict a scene flow of a next image frame by using the bidirectional scene flow feature. The flow predictor structure may repeatedly perform a scene flow prediction process of the next image frame by using a prediction flow as the input.

The weight generator 120 calculates a differentiation between a plurality of prediction results of a flow predictor (FP) for each hierarchy of a teacher model and ground truth data, and inputs the calculated differentiation into a predetermined inversed Softmax function to generate a weight. Here, the differentiation may be a value closer to 1 as the difference between the prediction result and the ground truth data is smaller.

The function generator 130 multiplies each of a plurality of prediction results of the flow predictor (FP) for each layer of the teacher model by the weight, and adds multiplication results to each other to calculate the loss function. Here, the loss function may be defined as Attentive Mixed Loss (AML).

The function generator 130 combines the loss function with a predetermined multi scale loss (MSL) function to finally generate the loss function. The multi scale loss (MSL) function may be acquired by a plurality of layers of a conventional model having different scales. Hereinafter, a final loss function may be defined as a training loss function.

The knowledge distiller 140 distills the knowledge of the teacher model to the student model by using the training loss function to generate a light-weighted student model. The light-weighted student model may be used for inferring a next scene flow of a continuous image frame.

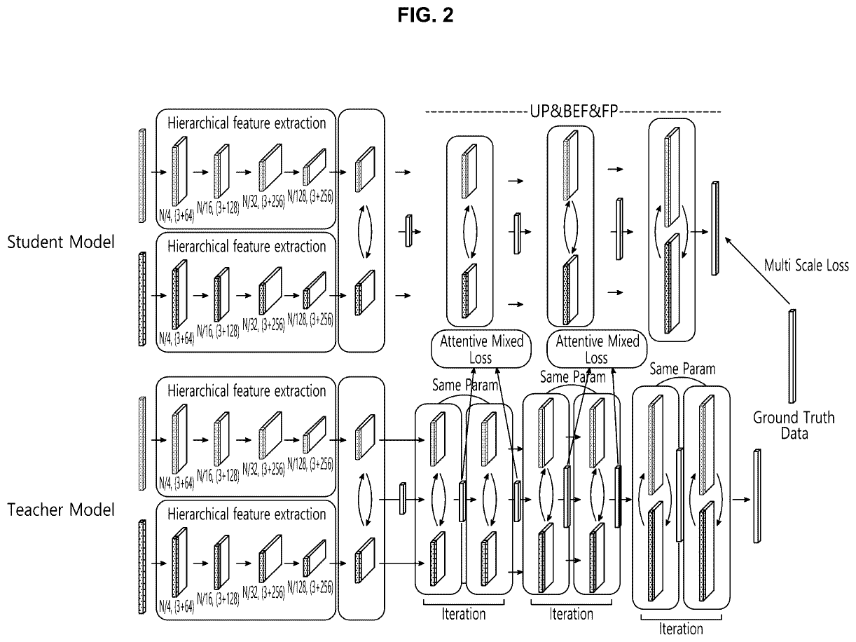

FIG. 2 is a diagram illustrating a knowledge distilling process of the apparatus for distilling knowledge for a flow prediction model according to an exemplary embodiment of the present disclosure.

Referring to FIG. 2, a teacher model including bidirectional flow embedding (BFE) and a flow predictor (FP) layer of an iteration performing structure, and a student model to which the knowledge of the teacher model is distilled may be confirmed.

The student model former 110 may form the student model by using single bidirectional flow embedding (BFE) and a flow predictor (FP) structure except for the iteration performing structure of the bidirectional flow embedding (BFE) and the flow predictor (FP) in the teacher model.

The weight generator 120 obtains a differentiation between a hierarchical prediction result of the flow predictor (FP) of the teacher model and ground truth data (data close a correct answer), and applies the differentiation to the inversed Softmax function to generate the weight.

The function generator 130 multiplies each of prediction results of the flow predictor (FP) for each hierarchy of the teacher model by the weight, and adds multiplication results to each other to calculate the loss function.

The function generator 130 combines the loss function with a predetermined multi scale loss (MSL) function to finally generate the training loss function.

The knowledge distiller 140 may distill the knowledge of the teacher model to the student model by using the training loss function.

The student model has teacher model level of accuracy, and has an effect in that a total computation amount is small and an inference speed is relatively higher than the related art.

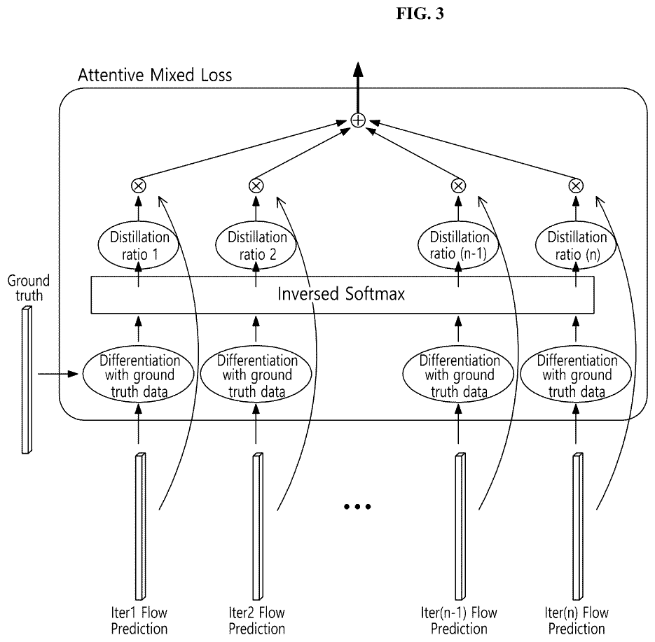

FIG. 3 is a diagram illustrating a loss function calculation process of the apparatus for distilling knowledge for a flow prediction model according to an exemplary embodiment of the present disclosure.

Referring to FIG. 3, in the teacher model, in order to increase the prediction performance simultaneously with maintaining a size, bidirectional feature detection parts may be iteratively applied in a bi-directional flow propagate (BFP) block of the bidirectional flow embedding (BFE) layer.

The weight generator 120 may calculate the differentiation between the flow prediction result of the flow predictor of the iteration performing structure and the ground truth data for each hierarchy.

The weight generator 120 may calculate the weight so that the hierarchical differentiation is made to pass through inversed Softmax to be expressed close to 1.

The function generator 130 multiplies the hierarchical prediction result and the weight, and adds the multiplication values to each other to calculate attentive mixed loss.

The function generator 130 combines a multi scale loss function of the existing model with the loss function to finally generate the training loss function.

The knowledge distiller 140 may distill the knowledge of the teacher model to the student model by using the loss function.

Equation 1 below shows a calculation equation of the loss function.

$$loss = MultiScaleLoss ( {x}_{pred} ) + AttentiveMixedLoss ( \text{?} ) \qquad < Equation 1 >$$

$$AttentiveMixedLoss ( \text{?} ) = \text{?} sum ( ‖ \text{?} - \text{?} ( \text{?} ) \text{?} )$$

$$\text{?} = InvSoftmax ( sum ( ‖ \text{?} - \text{?} ) )$$

$$\text{?} \text{indicates text missing or illegible when filed}$$

In Equation 1, loss represents the training loss function, AttentiveMixedLoss represents the loss function, and DistillRatio represents the weight.

L represents a variable meaning a stage of a training layer. I represents a variable representing an iteration number. t₁ᵢ means a flow prediction value of an 1-th stage and an i-th iter of the teacher model. GT₁ means a final flow value of the 1-th stage.

The student model may infer a next scene flow of a scene frame in a light-weighting state in the teacher model.

Meanwhile, a reason for applying the iteration structure of the bidirectional flow embedding of the iteration performing structure for bidirectional feature detection only the teacher model is that a higher inference performance is confirmed.

Table 1 below shows an example of a performance indicator for each model.

TABLE 1

| | | | | | FLOPs | #Params |
|---|---|---|---|---|---|---|
| | | EPE3D < | EPE3D < | EPE3D > | (computational | (number of |
| Model | EPE3D | 0.05 | 0.10 | 0.30 | amount) | parameters) |
| Baseline(w/o | 0.0288 m | 91.8% | 97.8% | 14.3% | 13.360G | 7.957M |
| iteration) | | | | | | |
| modified | 0.0280 m | 92.3% | 97.9% | 13.7% | 9.365G | 4.474M |
| hyper. | | | | | (30%↓) | (43%↓) |
| modified | 0.0255 m | 93.4% | 98.3% | 12.4% | 16.082G | 4.523M |
| hyper. | | | | | (20%↑) | (43%↓) |
| modified | 0.0239 m | 93.8% | 98.5% | 11.7% | 16.082G | 4.523M |
| hyper. & w | | | | | (20%↑) | (43%↓) |
| iteration = 2 | | | | | | |
| & Feature | | | | | | |
| based | | | | | | |
| Grouping | | | | | | |

However, there is a disadvantage in that applying the bidirectional flow embedding and the flow predictor of the iteration performing structure requires a high calculation amount in proportion to the iteration number. Further, an inference time also increases in proportion to a large calculation amount.

Accordingly, the apparatus 100 for distilling the knowledge of the scene flow prediction model according to an exemplary embodiment of the present disclosure selects a deep neural network model having a high performance as the teacher model by applying the bidirectional flow embedding and the flow predictor of the iteration performing structure, and selects a model that reduces the calculation amount and the inference time by excluding the iteration performing structure of the bidirectional flow embedding and the flow prediction as the student model to increase the performance of the student model.

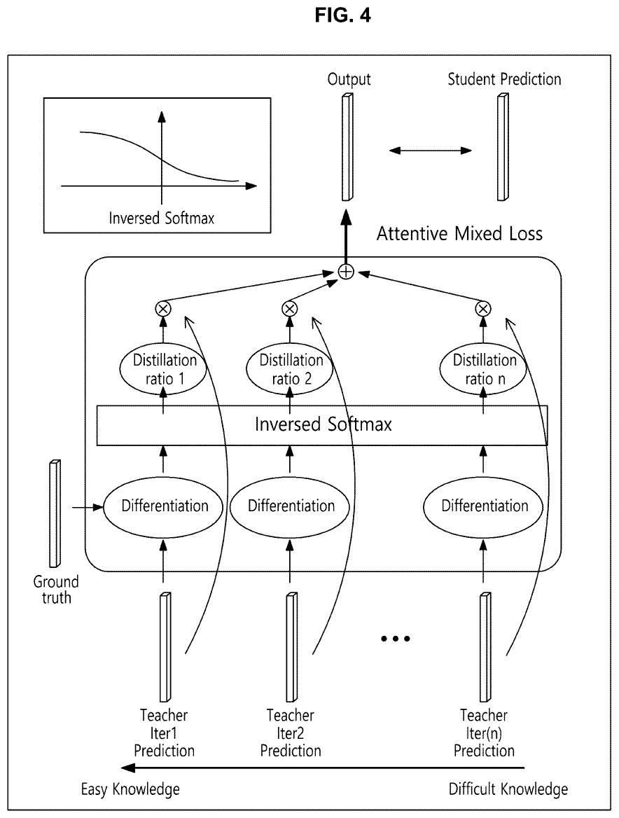

FIG. 4 is a diagram describing a generation process of a loss function.

Referring to FIG. 4, the loss function (attentive mixed loss (AML)) may convert the bidirectional flow embedding structure and a prediction value of the flow predictor of the teacher model (teacher Ierx prediction, a prediction value of x-th iteration of the teacher model) into a result value which the student model is easy to learn. That is, the loss function is a function that allows the student model to imitate the teacher model.

The weight generator 120 may calculate a differentiation between the flow prediction value according to the iteration performing structure of the teacher model and ground truth data.

The weight generator 120 may generate respective differentiations as a plurality of weight values (distillation ratio x) through inversed Softmax.

The function generator 130 multiplies the plurality of weight values and the prediction value of the teacher model, and then adds the multiplication values to each other to generate the loss function. In this case, the loss function becomes a value (output) which the student model is easy to imitate.

The function generator 130 may finally generate the training loss function (final loss) by using the prediction value, the loss function, and the multi scale loss function of the student model.

Such a process may be applied to various layers of the student model having different scales.

A general loss function may be used for the student model to learn a final flow prediction value of the teacher model, but there is a problem in that prediction values according to the iteration performing structure of the teacher model may not be appropriately utilized.

However, the apparatus 100 for distilling the knowledge according to an exemplary embodiment of the present disclosure may configure the loss function by using all flow prediction values according to the iteration performing structure of the teacher model.

That is, the apparatus 100 for distilling the knowledge according to an exemplary embodiment of the present disclosure may generate a weight value through the prediction value according to the iteration performing structure of the teacher model, and newly configure the training loss function which the student model is easy to imitate by using the weight value.

The apparatus 100 for distilling the knowledge according to an exemplary embodiment of the present disclosure applies a loss function generation process to each of layers having different scales of the teacher model to induce the student model to learn the teacher model in a multi-scale stage.

In the apparatus 100 for distilling the knowledge according to an exemplary embodiment of the present disclosure, the accuracy of the scene flow prediction becomes higher than that when applying a general knowledge distilling method when the student model learns the teacher model.

The apparatus 100 for distilling the knowledge according to an exemplary embodiment of the present disclosure is not limited to a field such as the scene flow prediction, and a loss function generation process may be applied in a process of light-weighting all models having the iteration performing structure.

Meanwhile, the inversed Softmax function as 1—Softmax is a function having an inverse proportion feature, and the inversed Softmax function has a larger value as an x value is smaller, and has a smaller value as the x value is larger.

As an input value of the inversed Softmax, a differentiation between the ground truth data and prediction data is input. As the prediction data and the ground truth data are more similar, the differentiation has a smaller value and as a difference between the prediction data and the ground truth data is larger, the differentiation has a larger value.

The inversed Softmax may generate a larger weight as the prediction data and the ground truth data are more similar.

The apparatus 100 for distilling the knowledge for the scene flow prediction model according to an exemplary embodiment of the present disclosure sets the weight value for the prediction of the bidirectional flow embedding and the flow predictor of the iteration performing structure of the teacher model to be similar to the ground truth data.

Further, the apparatus 100 for distilling the knowledge for the scene flow prediction model may induce the student model to imitate a last prediction value of the teacher model, which has highest accuracy, but assigns the weight to an initial prediction value having low accuracy to increase the inference accuracy of the student model.

Table 2 below shows an example of inference accuracy for each model.

TABLE 2

| Model | EPE3D | EPE3D < 0.05 | EPE3D < 0.30 |
|---|---|---|---|
| w/o AML | 0.0249 m | 93.4% | 12.6% |
| w AML | 0.0247 m | 93.5% | 12.5% |

Referring to Table 2, it can be seen that the initial prediction value having low inference accuracy of the teacher model is included in the student model to assist the learning of the student model.

That is, although the initial prediction value of the teacher model has low accuracy, the initial prediction value shows a distribution which the student model is easy to learn, and a late prediction value of the teacher model has high accuracy, but may be a distribution which the student model is difficult to learn.

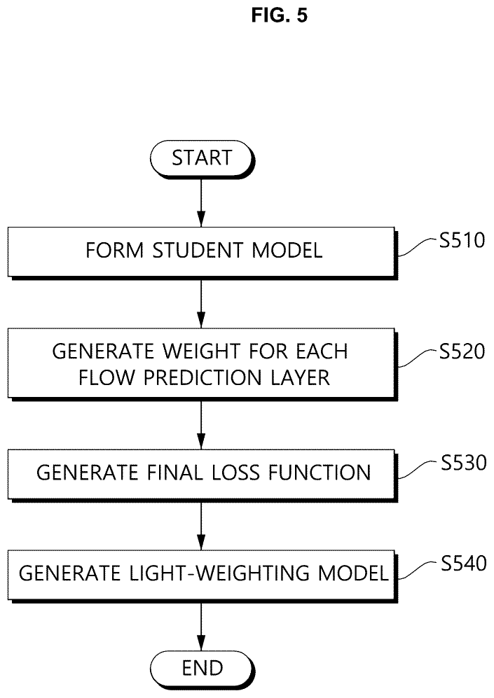

FIG. 5 is a flowchart of a method for distilling knowledge for a scene flow prediction model according to an exemplary embodiment of the present disclosure.

Referring to FIG. 5, the method for distilling knowledge for a scene flow prediction model according to an exemplary embodiment of the present disclosure includes a student model forming step (S510), a weight generating step (S520), a function generating step (S530), and a knowledge distilling step (S540).

In the student model forming step (S510), a student model former 110 may form a student model by using a structure other than an iteration performing structure in a teacher model. The iteration performing structure may be applied bidirectional flow embedding and a flow predictor of the teacher model.

In the weight generating step (S520), a weight generator 120 may calculate a differentiation between a hierarchical flow prediction result of the teacher model and predetermined ground truth data. The weight generator 120 inputs the differentiation into an inversed Softmax function to generate a weight.

In the function generating step (S530), a function generator 130 multiplies the hierarchical flow prediction result of the teacher model by the weight, and adds multiplication results to each other to generate a loss function. The loss function may be defined as Attentive Mixed Loss (AML). The function generator 130 adds a predetermined multi-scale loss function to the loss function to finally generate a training loss function.

In the knowledge distilling step (S540), A knowledge distiller 140 may distill the knowledge of the teacher model to the student model by using the training loss function. Through this, a light-weighted student model may be generated.

The above description just illustrates the technical spirit of the present disclosure and various changes, modifications, and substitutions can be made by those skilled in the art to which the present disclosure pertains without departing from an essential characteristic of the present disclosure. Therefore, the embodiments and the accompanying drawings disclosed in the present disclosure are used to not limit but describe the technical spirit of the present disclosure and the scope of the technical spirit of the present disclosure is not limited by the embodiments and the accompanying drawings.

The steps and/or operations according to the present disclosure may occur in different orders, in parallel, or concurrently in other exemplary embodiments for other epochs or the like, as may be understood by those skilled in the art.

Depending on the exemplary embodiment, at least some or all of the steps and/or operations may be implemented or performed by using commands, programs, and interactive data structures stored in one or more non-transitory computer-readable media, and one or more processors driving a client and/or a server. The one or more non-transitory computer-readable media may be, by way of example, software, firmware, hardware, and/or any combination thereof. Further, the functions of the “module” discussed in this specification may be implemented by software, firmware, hardware, and/or any combination thereof.

As described above, the exemplary embodiments have been described and illustrated in the drawings and the specification. The exemplary embodiments were chosen and described in order to explain certain principles of the disclosure and their practical application, to thereby enable others skilled in the art to make and utilize various exemplary embodiments of the present disclosure, as well as various alternatives and modifications thereof. As is evident from the foregoing description, certain aspects of the present disclosure are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

What is claimed is:

1. An apparatus for distilling knowledge for a scene flow prediction model, the apparatus comprising:
a controller comprising:
a student model former configured to form a student model to have single bidirectional flow embedding and a flow predictor structure of a teacher model;
a weight generator configured to generate a weight based on a plurality of hierarchical prediction results of the teacher model and predetermined ground truth data;
a function generator configured to generate a loss function by using the weight and the plurality of prediction results; and
a knowledge distiller configured to distill the knowledge of the teacher model to the student model by using the loss function.

2. The apparatus of claim 1, wherein the weight generator calculates a differentiation between the plurality of hierarchical prediction results of the teacher model and the ground truth data, and inputs the calculated differentiation into a predetermined inversed Softmax function to generate the weight.

3. The apparatus of claim 2, wherein the function generator multiplies the plurality of respective hierarchical prediction results of the teacher model by the weight, and adds multiplication results to each other to calculate the loss function.

4. The apparatus of claim 3, wherein the function generator combines the loss function with a predetermined multi scale loss function to generate a training loss function for the student model.

5. The apparatus of claim 4, wherein the knowledge distiller distills the knowledge of the teacher model to the student model by using the training loss function.

6. The apparatus of claim 1, wherein the teacher model has bidirectional flow embedding and a flow predictor structure of an iteration performing structure.

7. A method for distilling knowledge for a scene flow prediction model, the method comprising:
forming, by a student model former of a controller, a student model to have single bidirectional flow embedding and a flow predictor structure of a teacher model;
generating, by a weight generator of the controller, a weight based on a plurality of hierarchical prediction results of the teacher model and predetermined ground truth data;
generating, by a function generator of the controller, a loss function by using the weight and the plurality of prediction results; and
distilling, by a knowledge distiller of the controller, the knowledge of the teacher model to the student model by using the loss function.

8. The method of claim 7, wherein generating the weight includes:
calculating, by the weight generator, a differentiation between the plurality of hierarchical prediction results of the teacher model and the ground truth data, and inputting the calculated differentiation into a predetermined inversed Softmax function to generate the weight.

9. The method of claim 8, wherein generating the loss function includes:
multiplying, by the function generator, the plurality of respective hierarchical prediction results of the teacher model by the weight, and adding multiplication results to each other to calculate the loss function.

10. The method of claim 9, wherein generating the loss function further includes:
combining, by the function generator, the loss function with a predetermined multi scale loss function to generate a training loss function for the student model.

11. The method of claim 10, wherein distilling the knowledge includes:
distilling, by the knowledge distiller, the knowledge of the teacher model to the student model by using the training loss function.

12. The method of claim 7, wherein the teacher model has bidirectional flow embedding and a flow predictor structure of an iteration performing structure.

13. A non-transitory computer readable medium containing program instructions executed by a processor, the computer readable medium comprising:
program instructions that form a student model to have single bidirectional flow embedding and a flow predictor structure of a teacher model;
program instructions that generate a weight based on a plurality of hierarchical prediction results of the teacher model and predetermined ground truth data;
program instructions that generate a loss function by using the weight and the plurality of prediction results; and
program instructions that distill the knowledge of the teacher model to the student model by using the loss function.
